(19) United States
(12) Patent Application Publication
(10) Pub. No.: US 2023/0115910 A1
(43) Pub. Date: Apr. 13, 2023

(54) MOUTHPIECE FOR WHITENING TEETH

(71) Applicant: LAV Inc., Seoul (KR)

(72) Inventors: Jeong Woo CHOI, Seoul (KR); Jae Myoung LEE, Seoul (KR)

(21) Appl. No.: 17/929,987

(22) Filed: Sep. 6, 2022

(30) Foreign Application Priority Data
Sep. 6, 2021 (KR) 10-2021-0118117

(51) Int. Cl. A61C 19/06

(52) U.S. Cl. CPC A61C 19/066

(57) ABSTRACT

The present invention relates to a mouthpiece for teeth whitening. Particularly, it relates to a mouthpiece for teeth whitening to alleviate dilution of a tooth whitening gel by saliva and to improve breathing of a user. The first aspect of the invention relates to a mouthpiece for teeth whitening comprises a body and a tongue rest, and the body further comprises an outer surface, an inner surface and an air vent penetrating the outer surface and the inner surface. The air vent has an inner side opening formed at a portion extending toward the user's oral cavity by a predetermined length from the inner surface, and an extended portion of the air vent toward the user's oral cavity is connected to the tongue rest.

### CROSS-REFERENCE TO RELATED APPLICATION

This application claims priority to Korean Patent Application No. 10-2021-0118117, filed on Sep. 6, 2021 in the Korean Intellectual Property Office, the disclosures of which are incorporated by reference herein in their entireties.

### TECHNICAL FIELD

The present invention relates to a mouthpiece for teeth whitening. Particularly, it relates to a mouthpiece for teeth whitening to alleviate dilution of a tooth whitening gel by saliva and to improve breathing of a user.

### DISCUSSION OF THE RELATED ART

There are four types of whitening techniques that are widely used for teeth whitening.

The first type is a “strip” type, in which a strip with a whitening effect is attached to the outer surface of the user's teeth (mainly the front teeth.) However, this has a problem that it does not achieve a desired whitening effect because it tends to easily separate from the surface by the saliva of the user during teeth whitening.

The second type is a “pen” type, in which a gel-like preparation with a whitening effect is directly applied to the teeth. This also has problems such as the applied whitening gel-like preparation flowing down or mixed with saliva and diluted.

The third type is a “mouth gag” type, in which a fixing device that opens the user's lips by an external force is attached so that the anterior teeth of the upper and lower jaw are exposed, and a whitening agent is applied to the outer surface of the exposed teeth. This still has the same problems such as the applied whitening gel flowing down or mixed with saliva and diluted. Furthermore, there is another problem that the user feels discomfort in the lips and temporomandibular joint because mouth needs to keep open for a long time during tooth whitening.

The fourth type is a “mouthpiece” type, in which the tooth whitening gel is applied to the inner wall of the mouthpiece and the user bites the mouthpiece for a certain period of time so that the tooth whitening gel contacts the outer surface of the anterior portion. This still has problems such as the applied whitening gel flowing down or mixed with saliva and diluted. Furthermore, in the case of a user who does not easily breathe through the nose due to a disease such as rhinitis, he/she may have difficulty breathing. Also, there is still another problem that the dilution of the whitening gel gets thinner due to the mixture of more saliva, which is secreted when the tongue keeps moving due to its unstable position.

### SUMMARY

The first aspect of the invention relates to a mouthpiece for teeth whitening comprises a body and a tongue rest, and the body further comprises an outer surface, an inner surface and an air vent penetrating the outer surface and the inner surface. The air vent has an inner side opening formed at a portion extending toward the user's oral cavity by a predetermined length from the inner surface, and an extended portion of the air vent toward the user's oral cavity is connected to the tongue rest.

In addition, it is preferable that a plurality of bumps are further formed on the inner surface to help the tooth whitening gel adhere to the inner surface.

In addition, it is preferable that a protruded portion crossing the inner surface and having a predetermined thickness is further formed so that the upper and lower jaws of the user are occluded at an angle widened by the thickness.

In addition, it is preferable that the protruded portion is formed to be connected to the tongue rest.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 shows an embodiment of a mouthpiece for teeth whitening.

FIG. 2 shows a rear view of the embodiment of FIG. 1, viewed from the user's direction.

FIG. 3 shows is a top view of the embodiment of FIG. 1.

FIG. 4 shows a cross-sectional view of the embodiment of FIG. 1 illustrating the arrangement of the mouthpiece and the user's teeth and tongue.

### DETAILED DESCRIPTION OF EXEMPLARY EMBODIMENTS

Hereinafter, an embodiment of a mouthpiece for teeth whitening will be described in detail with reference to the accompanying drawings.

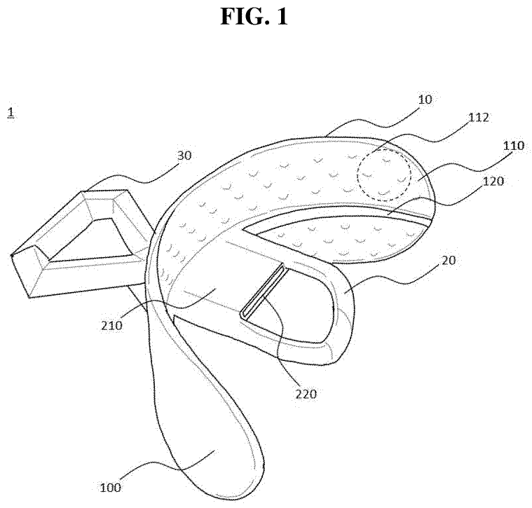

FIG. 1 shows an embodiment of a mouthpiece for teeth whitening.

As shown in FIG. 1, an exemplary mouthpiece for teeth whitening 1 comprises a body 10, a tongue rest 20, and a handle 30.

The body 10 further comprises an outer surface 100 and an inner surface 110, and a plurality of bumps 112 are further formed on the inner surface 110. The plurality of bumps 112 are formed to improve the adhesion between the tooth whitening gel and the inner surface 110.

An air vent 220 is formed to penetrate the outer surface 110 and the inner surface 110 in the body 10. The air vent 220 may be formed so that the upper part of the air vent 210 is connected to the tongue rest 20. In this case, the user's tongue rests on both of the tongue rest 20 and the upper part 210 of the air vent 220. Since the inner side opening is formed on the inner surface 110 lower than the user's tongue so that the opening doesn't contact the tongue, even if the user breathes through the mouth, the saliva doesn't leak out through the opening on the inner surface 110 of the air vent 220 despite the pressure of mouth breathing.

In addition, a protruded portion 120 is further formed to cross the central portion of the inner surface 110. The protruded portion 120 is formed to protrude about several mm from the inner surface 110 and performs two roles.

Firstly, it allows the tooth whitening gel applied to the upper teeth to flow less down the lower teeth. Since the tooth whitening gel has viscosity, when the tooth whitening gel is applied to the upper teeth, the gel remains between the inner surface 110 and the upper teeth with the aid of the protruded portion 120 and the bumps 112.

Secondly, it increases the angle of the occlusion between the upper and lower jaws when the user wears the tooth whitening mouthpiece 1.

In general, when the mouthpiece is worn for a long time to gain the whitening effect, there are cases in which the users complain of the pain in the temporomandibular joint.

The mouthpiece 1 described in FIG. 1 is formed to have an angle between the lower and upper jaws when the user bites it to reduce such pain. The protruded portion 120 serves to widen the angle of the upper and lower jaws.

The mouthpiece for teeth whitening 1 is worn so that the outer surface 100 of the body 10 is disposed between the inside of the users lips and the outer surface of the teeth, and the handle 30 is disposed outside the lips.

In FIG. 1, the exemplary shape of the handle 30 is illustrated as a polyhedron, but this is mere an example, and any structure and shape capable of being used to wear/remove the mouthpiece 1 are applicable.

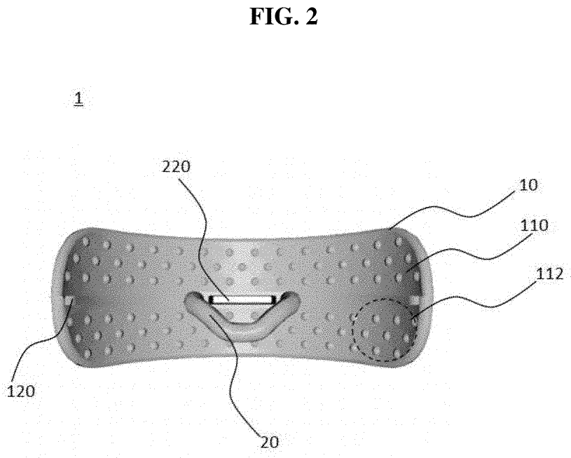

FIG. 2 shows a rear view of the embodiment of FIG. 1, viewed from the users direction.

The same reference numerals denote the same elements throughout the specification as well as in FIG. 2.

As shown in FIG. 2, the tongue rest 20 is formed to be a ring shape protruding from the protruded portion 120 of the inner surface 110 toward the oral cavity of the user. And the end of the ring of the tongue rest 20 is formed to have a shape slightly bent downward. This helps the tongue be easily rested on the tongue rest 20 without causing any discomfort or pain.

The air vent 220 is formed at the portion where both ends of the ring of the tongue rest 20 contacts the inner surface 110.

The plurality of bumps 112 are formed on the inner surface 110 of the body 10 to help better adhesion of the tooth whitening gel, as described with reference to FIG. 1.

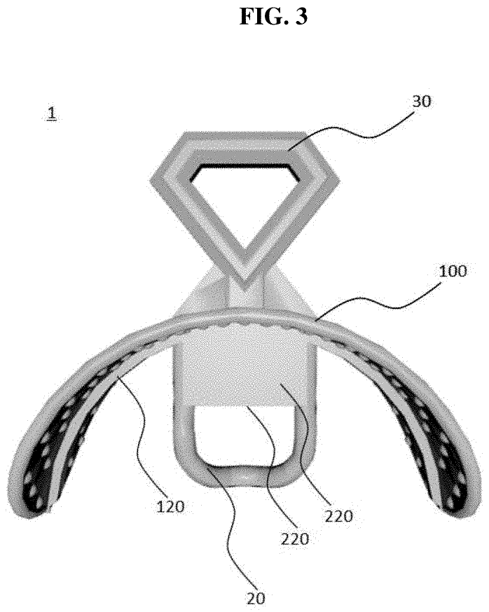

FIG. 3 shows is a top view of the embodiment of FIG. 1.

As shown in FIG. 3, the tongue rest 20 protrudes from the inner surface 110, and is formed to have a shape that the upper part 210 of the air vent covers at least a portion of the protruded portion.

This is to ensure that the inner side opening of the air vent 220 is formed at an area spaced apart from the inner surface 110.

If the inner side opening of the air vent 220 is formed very close to the inner surface 110, the tooth whitening gel mixed with saliva may easily leak out through the air vent 220 during the mouth breathing.

However, in the present embodiment, the inner side opening of the air vent 220 is formed at a location spaced apart from the inner surface 110, so that when the user breathes through the mouth, he/she exhalates from the oral cavity to the air vent 220. Therefore, even if the tooth whitening gel is mixed with saliva in the user's mouth, it remains unmixed with exhalated breath.

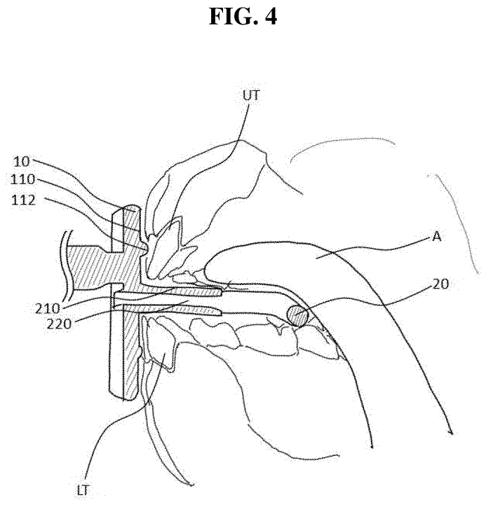

FIG. 4 shows a cross-sectional view of the embodiment of FIG. 1 illustrating the arrangement of the mouthpiece and the user's teeth and tongue.

As shown in FIG. 4, the tooth whitening gel (not shown) is applied between the user's upper teeth (UT: Upper Teeth), lower teeth (LT: Lower Teeth) and the inner surface 110. As previously described, the plurality of bumps 112 and protruded portion 120 out of the inner surface 110 help the tooth whitening gel better adhere to the inner surface 110.

Also, as described above with reference to FIG. 1, the upper teeth UT and the lower teeth LT are occluded with the widened position by the thickness of the protruded portion 120.

In this embodiment, the exemplary thickness of the protruded portion 120 is the same as the thickness of the tongue rest 20, but is not necessarily the same.

FIG. 4 shows that the user's tongue “A” rests on the tongue rest 20 and the upper part of the air vent 210.

As such, the inner side opening of the air vent 220 is spaced apart from the user's tongue “A” and the inner surface 110, so that the user's exhalated breath is not mixed with the tooth whitening gel mixed with saliva, and the user can comfortably breathe through the mouth.

mouthpiece for teeth whitening: 1

body: 10

tongue rest: 20

handle: 30

outer surface: 100

inner surface: 110

bumps 112

protruded portion 120

upper part of the air vent: 210

air vent: 220

What is claimed is:

1. A mouthpiece for teeth whitening comprising a body and a tongue rest,
wherein the body further comprising an outer surface, an inner surface and an air vent penetrating the outer surface and the inner surface;
wherein the air vent is formed to have an inner side opening at a portion extending toward the user's oral cavity by a predetermined length from the inner surface; and
wherein an extended portion of the air vent toward the user's oral cavity is connected to the tongue rest.

2. The mouthpiece for teeth whitening of claim 1, further comprising:
a plurality of bumps formed on the inner surface to help the tooth whitening gel adhere better to the inner surface.

3. The mouthpiece for teeth whitening of claim 1, further comprising:
a protruded portion formed to cross the inner surface and to have a predetermined thickness, so that the upper and lower jaws of the user are occluded at a widened angle by the thickness.

3. The mouthpiece for teeth whitening of claim 3,
wherein, the protruded portion is formed to be connected to the tongue rest.
